(19) United States
(12) Patent Application Publication
(10) Pub. No.: US 2003/0022777 A1
(43) Pub. Date: Jan. 30, 2003

(54) Process for the removal of stacks of bags from a chain of stacks of bags and device for carrying out the process

(76) Inventors: Hans-Ludwig Voss, Tecklenburg (DE); Konrad Tetenborg, Lengerich (DE)

Correspondence Address: JACOBSON HOLMAN PLLC, 400 SEVENTH STREET N.W., SUITE 600, WASHINGTON, DC, 20004, US

(21) Appl. No.: 10/184,822

(22) Filed: Jul. 1, 2002

(30) Foreign Application Priority Data
Jul. 27, 2001 (DE) 101 36 666.3
Nov. 5, 2001 (DE) 101 54 307.7

(51) Int. Cl. B31B 1/64

(52) U.S. Cl. 493/204

(57) ABSTRACT

The invention relates to a process for removing stacks of bags from a chain of stacks of bags and a device for carrying out this process. According to the invention, in a removal station the stack of bags is grasped by a robot arm by means of grippers. The hollow core of a pin is expanded in such a manner by means of a robot-sided mandrel with expandable peripheral surface that the clamped pin lock is loosened; and then the stack of bags is lifted off the supporting web by means of robot-sided grippers.

The invention relates to a process for removing stacks of bags, in particular comprising plastic packaging bags, from a chain of stacks of bags and a device for carrying out this process.

The earlier application DE (file number 01638-01), which has not been prepublished, already describes a process for collecting bags in the form of chains of stacks of bags. Usually bags, made of plastic, preferably polyethylene, are collected to form these chains of stacks of bags. According to this embodiment described there, the plastic packaging bags are disposed on a supporting web in the form of a chain of stacks of bags. The bags, collected into stacks of bags, are connected together by way of lips, formed on their open side, and tacked so as to be staggered onto a supporting web by means of fastening means. These fastening means comprise a pin, whose core is hollow and which exhibits a clamped pin lock. In the aforementioned application it is described in detail how the chain of stacks of bags can be produced by machine by bringing the stacks of bags onto the supporting web.

In the aforementioned application the chains of stacks of bags are wound into rolls, where the stacks of bags lie externally on the supporting web and are wound correspondingly. Inversely the stacks of bags can also lie, of course, internally on the supporting web and be rolled into a roll.

The object of the present invention is to provide a process for the removal of stacks of bags from such a chain of stacks of bags and a device for carrying out this process.

The invention solves this problem by means of the features of claim 1. Correspondingly a process for the removal of stacks of bags, constructed as disclosed in detail in the preamble of claim 1, is proposed, wherein in a removal station the stack of bags is grasped by a robot arm by means of grippers, wherein by means of suitable means the pin lock is separated from the pin. At the same time, according to a preferred embodiment of the invention, which is put under protection in claim 2, at least one robot-sided mandrel with expandable peripheral surface is inserted into the hollow core of the pin and wherein by expanding the peripheral surface of the mandrel the pin is expanded to the extent that the clamped pin lock is loosened and that the stack of bags is lifted off the supporting web by means of the robot-sided grippers.

Other preferred embodiments of the process are disclosed in claims 3 to 6.

Correspondingly the stack, lifted off the supporting web by means of robot-sided grippers, can be deposited on a table or a conveyor belt in such a manner that the at least one mandrel, provided on this conveyor belt or table, can be inserted into the recesses in the stack of bags, wherein the at least one pin, which connected the stack of bags previously to the supporting web, is pulled out while the stack of bags is deposited on the conveyor belt or the table.

After being lifted off the supporting web, the stack of bags, grasped by the robot-sided grippers, can be positioned over the position of deposit above the conveyor belt or table and can be lowered by correspondingly lowering the robot-sided gripper arms relative to the robot-sided mandrel, with which the hollow core pin is fixed in position. This lowering operation pulls the fixed, hollow core pin out of the corresponding opening in the stack of bags, and at the same time the stack of bags is slipped over the mandrel, positioned on the conveyor belt or the table, by means of this opening. Following transfer, the stack of bags can be fed by a well-known method over a conveyor belt to a filling station.

It is especially advantageous if the chain of stacks of bags is unwound from a reel for the purpose of removing individual stacks of bags. During this operation the chain of stacks of bags or the supporting sheet of this chain of stacks of bags is guided over deflection rollers; and the stacks of bags of the chain of stacks of bags are fed cyclically to the removal station and removed there by means of the robot arm. Following removal of the respective stacks of bags, the supporting sheet is wound up again onto a reel.

During transport into the removal station, the individual stacks of bags are guided with the pin lock into a corresponding slot in a bearing plate and fixed in position there for removal of the stack of bags. Thus, the position of the respective pins is clearly defined, so that the robot-sided grippers can reach reliably with the corresponding mandrel into the interior of the hollow pins.

Devices for carrying out the process of the invention are disclosed in claims 7 to 10. Correspondingly, the robot arm exhibits, according to the invention, side grippers, by means of which the stacks of bags can be grasped from the side.

The expandable peripheral surface of the robot-sided mandrel can comprise a rubber collar, which can bulge over a shortening of the mandrel.

The robot-sided mandrel can exhibit on its free end an expanded head in such a manner that it can push the released pin lock out of the hollow core of the pin.

At least one photocell can be disposed in such a manner next to the course of the supporting sheet that the removal position of the stack of bags can be defined. To this end, the photocell detects the edge of a stack of bags that runs backwards or forwards. Usually said edge projects laterally over the supporting sheet so that the correct position of the stack of bags in the removal station can be determined with precision here.

In place of the robot-sided mandrel with expandable peripheral surface it is also conceivable that the means for expanding the hollow core of the pin comprise three or more fingers that are disposed in such a manner on the grippers that they can be moved toward each other or away from each other and thus can expand the hollow core of the pin in a manner similar to the above described robot-sided mandrel. However, other similar acting means for separating the pin lock from the pin can be used.

Other details and advantages of the invention follow from an embodiment depicted in the drawings.

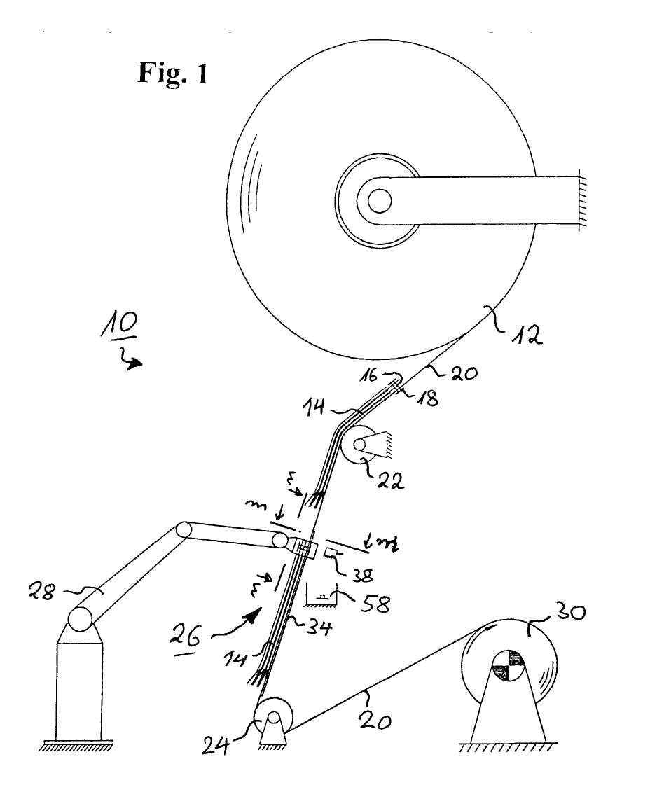

FIG. 1 is a simplified side view, partially cut, of a device for removing a stack of bags from a chain of stacks of bags, according to the present invention.

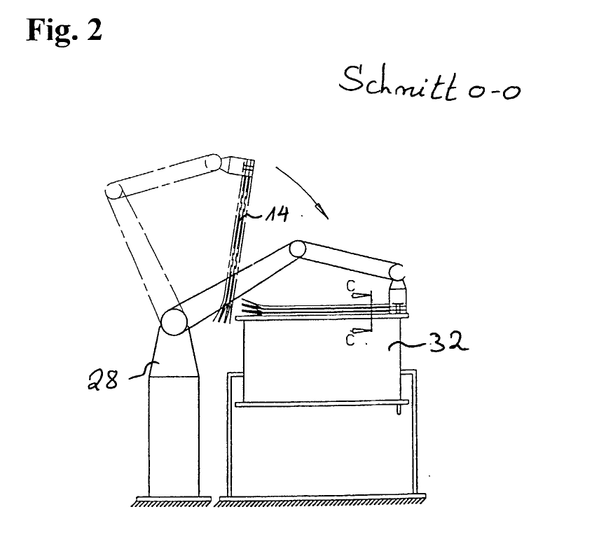

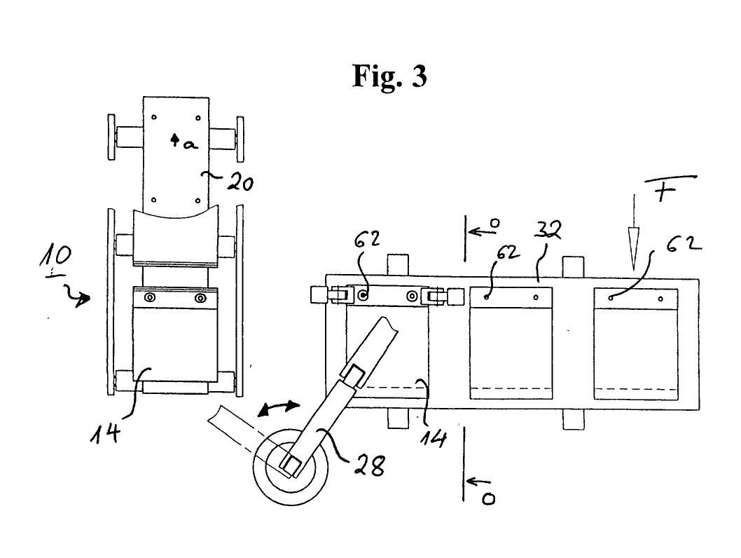

FIG. 2 is a detail of the device, according to FIG. 1, corresponding to the section o-o of FIG. 3, where here another processing station is also shown.

FIG. 3 is a top view of the device, according to FIG. 1, and the additional device, according to FIG. 2.

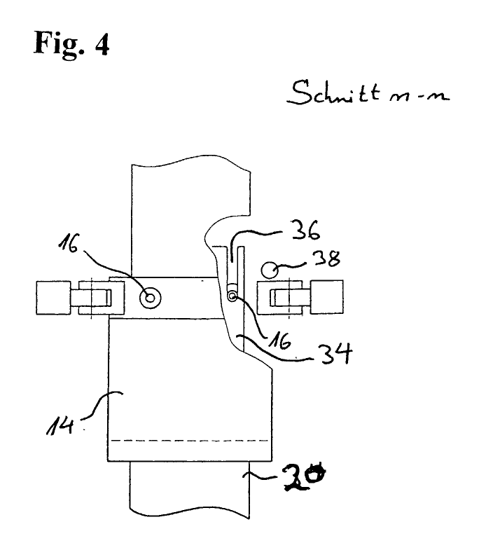

FIG. 4 is a sectional view n-n, according to FIG. 1.

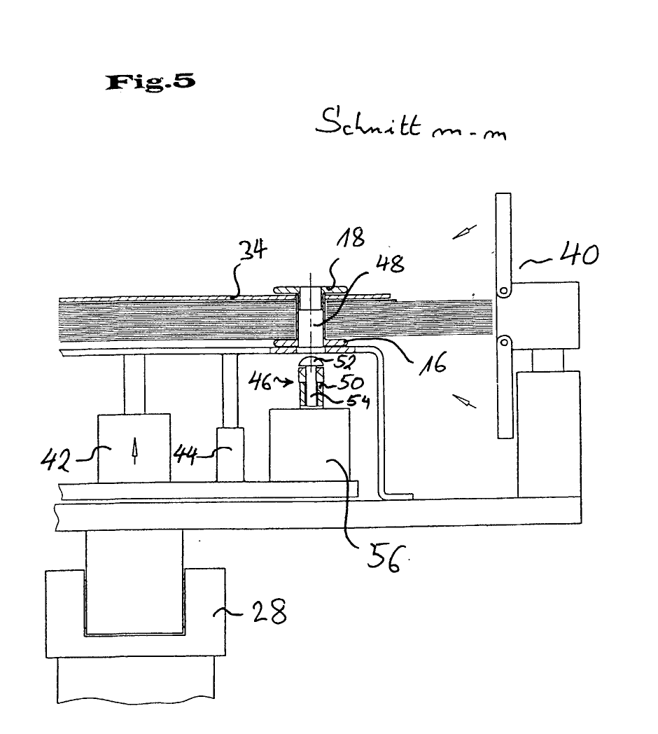

FIG. 5 is a sectional view m-m, according to FIG. 1, in a first working phase during the removal of the stack of bags.

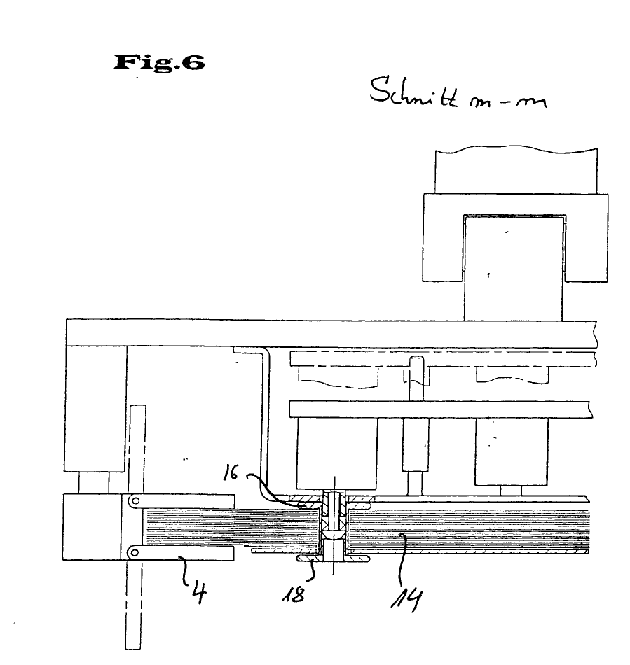

FIG. 6 is a sectional view m-m, according to FIG. 1, in a second working phase during the removal of the stack of bags, and

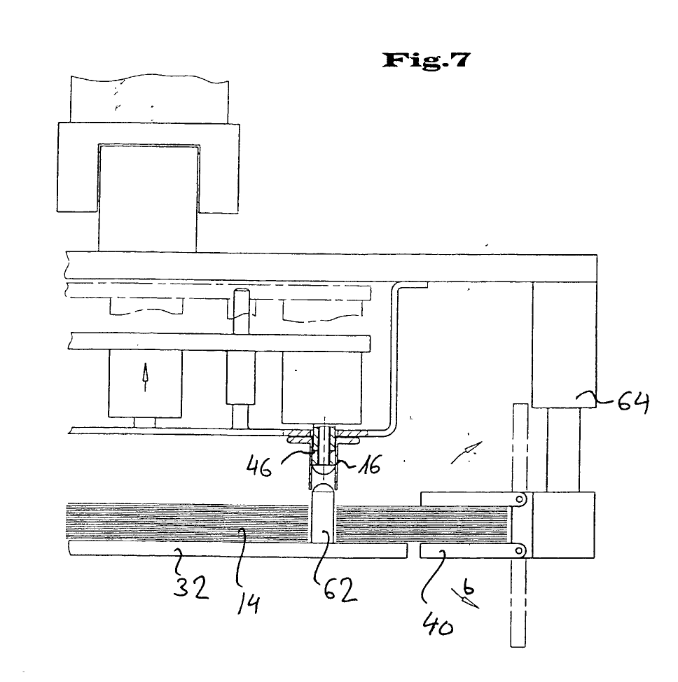

FIG. 7 is a drawing according to FIGS. 5 and 6, during the depositing of the stack of bags on the conveyor belt or the table, according to FIG. 3.

FIG. 1 depicts a device for carrying out the inventive process, all of which is marked 10. It shows here the process of unwinding a chain of stacks of bags from a reel 12; and the individual stacks 14 of bags are removed. The stacks 14 of bags are connected to a supporting sheet 20 by means of pins 16, which are locked by means of a pin lock 18. In the embodiment presented here the chains of stacks of bags are wound in such a manner onto the reel 12 that the supporting web 20 lies externally; thus, the respective stacks 14 of bags come to rest below the related supporting web 20. The chains of stacks of bags are unwound from the reel 12 and guided over deflection rollers 22, 24.

In a removal station 26 the individual stacks 14 of bags are grasped by a robot arm 28 and released from the supporting web 20 in a way that will be described in greater detail below. Following removal of the stacks of bags, the now empty supporting web 20 is rolled up again into a roll 30 after deflection around the deflection roll 24.

FIG. 2 shows how the robot arm 28 (indicated in part by a dashed line) deposits the grasped stack 14 of bags on a table 32 of a known filling machine.

The situation of removing from the device 10 and depositing on the table 32 is shown from the top once again in FIG. 3, where the robot is shown here in the different positions in part by means of a dashed line and in part by means of a continuous line in a schematic drawing. In FIG. 3, the supporting web 20 is moved in the direction of the arrow a. The table 32 can be moved back and forth so that the deposited stacks 14 of bags are fed to a filling funnel, which is not shown in detail here and which is indicated only by an arrow F.

With the aid of FIGS. 4 and 6 it is described at this point how the stack 14 of bags is removed in the removal station 26. The removal station 26 is defined in its position by means of a plate 34, which runs below the supporting web 20. The plate 34 exhibits a slot for receiving these pins 36 in the area, in which the pins 16 are arranged. If, as shown here, two parallel pins 16 are provided, the corresponding plate 34 exhibits two slots 36 arranged side-by-side. While the supporting web continues to travel with a corresponding stack of bags, the pins 16, connecting the stack 14 of bags to the supporting web 20, are inserted with their pin lock 18 into the corresponding slots 36 and fixed in position there at the end. Upon reaching the end of the slots 36, the stack 14 of bags is fixed in position locally in the removal station 26. The operation of reaching this removal position is monitored by one or more photosensor(s) 38 (see also FIG. 1).

With the aid of the section m-m in FIG. 5, it is shown at this point, what happens after the stack 14 of bags has been fixed in the removal position. The robot arm 28 has side grippers 40 for grasping the edge of the stacks of bags. As depicted in FIG. 5, the grippers 40 are steered in, upon reaching the removal position. In FIG. 6 the grippers are shown with the continuous line in the steered-in position, in which they hold the edge of the stack 14 of bags. After the grippers 40 have seized the stack of bags, a mandrel 46 moves via corresponding lifting cylinders 42 and a parallel guide 44 into the central cavity 48 of the pin 16. The mandrel 46 has a rubber jacket 50, which can swell over the moveable pin 54, provided with a head 52, in such a manner that the periphery of the mandrel 46 expands. Upon insertion of the mandrel 46 by way of the lifting cylinders 42 into the interior of the pin 16, the moveable pin 54 can be retracted so far by means of a clamping cylinder 56 that the rubber jacket 50 bulges and thus fixes and expands the pin 16 owing to its circumferential expansion. In this manner the pin lock 18, which is received so as to jam, is loosened so that it essentially drops out of the pin 16 due to gravity and can be caught in a container 58 (see FIG. 1). Optionally owing to the corresponding motion of the pin head 52 the pin lock can also be pushed out of the pin. After the pin lock 18 has been suitably removed, the stack 14 can be removed from the supporting web 20 and moved in the above described manner in the direction of the table 32, on which the respective mandrels 62 are arranged. These mandrels are depicted in FIG. 7. After the robot arm has been positioned above the table 32, the stack 14 of bags, which is still grasped by the grippers 40, can be lowered by means of corresponding piston cylinder arrangements 64. In this manner the stack 14 of bags is pulled away from the pin 16, which is still fixed in position by means of the mandrel 46. The opening that has become free is slipped over the table-sided mandrel 62. After positioning on the mandrels 62, the grippers 40 are moved in the direction of the arrow b in FIG. 7 into an opened position (indicated by the dashed line); and the robot arm can be moved back again in order to start the next removal cycle.

After the stack of bags has been deposited, it is further processed in the known manner in the filling station.

1. Process for removing stacks of bags, in particular comprising plastic packaging bags, from a chain of stacks of bags, said chain comprising stacks of bags, which exhibit several bags and are arranged on a supporting web, wherein the stacks of bags are connected to the supporting web by means of at least one hollow core pin with a clamped pin lock, characterized in that in a removal station the stack of bags is grasped by a robot arm by means of grippers; and that the pin lock is separated from the pin by way of suitable means.

2. Device, as claimed in claim 1, characterized in that, as means for separating the pin lock from the pin, at least one robot-sided mandrel with expandable peripheral surface is inserted into the hollow core of the pin; that by expanding the peripheral surface of the mandrel the pin is expanded to the extent that the clamped pin lock is loosened and that the stack of bags is lifted off the supporting web by means of the robot-sided grippers.

3. Process, as claimed in claim 2, characterized in that the stack, lifted off the supporting web by means of robot-sided grippers, is deposited on a table or a conveyor belt in such a manner that the at least one mandrel, provided on this conveyor belt or table, can be inserted into the recesses in the stack of bags, wherein the at least one pin, which connected the stack of bags previously to the supporting web, is pulled out while the stack of bags is deposited on the conveyor belt or the table.

4. Process, as claimed in claim 3, characterized in that, after being lifted off the supporting web, the stack of bags, grasped by the robot-sided grippers, is positioned over the position of deposit above the conveyor belt or table and is lowered by correspondingly lowering the robot-sided gripper arms relative to the robot-sided mandrel, with which the hollow core pin is fixed in position.

5. Process, as claimed in any one of the claims 1 to 4, characterized in that for the purpose of removing individual stacks of bags, the chain of stacks of bags is unwound from a reel and is guided over deflection rollers; and that, following removal of the respective stacks of bags, the supporting sheet is wound up again onto a reel.

6. Process, as claimed in any one of the claims 1 to 5, characterized in that during transport into the removal station, the individual stacks of bags are guided with the pin lock into a corresponding slot in a bearing plate and fixed in position there for removal of the stack of bags.

7. Device for carrying out the process, as claimed in any one of the claims 1 to 6, characterized in that the robot arm exhibits side grippers, by means of which the stacks of bags can be grasped from the side.

8. Device, as claimed in claim 7, characterized in that the expandable peripheral surface of the robot-sided mandrel comprises a rubber collar, which can bulge over a shortening of the mandrel.

9. Device, as claimed in claim 8, characterized in that the robot-sided mandrel exhibits on its free end an expanded head in such a manner that it can push the released pin lock out of the hollow core of the pin.

10. Device, as claimed in any one of the claims 5 to 9, characterized in that at least one photocell is disposed in such a manner next to the course of the supporting sheet that the removal position of the stack of bags can be defined.
